(19) United States
(12) Patent Application Publication
(10) Pub. No.: US 2026/0222708 A1
(43) Pub. Date: Jul. 30, 2026

(54) DIGITAL PIXEL SENSOR AND METHOD INCLUDING THE SAME

(71) Applicant: SAMSUNG ELECTRONICS CO., LTD., Suwon-si (KR)

(72) Inventors: Sanggwon Lee, Suwon-si (KR); Minwoong Seo, Suwon-si (KR); Heesung Shim, Suwon-si (KR); Masamichi Ito, Suwon-si (KR)

(73) Assignee: SAMSUNG ELECTRONICS CO., LTD., Suwon-si (KR)

(21) Appl. No.: 19/448,424

(22) Filed: Jan. 14, 2026

(30) Foreign Application Priority Data
Jan. 24, 2025 (KR) 10-2025-0011849

(51) Int. Cl. H04N 25/771; H04N 25/772; H04N 25/79

(52) U.S. Cl. CPC H04N 25/771; H04N 25/772; H04N 25/79

(57) ABSTRACT

A digital pixel includes at least one photodetection circuit that receives a light signal and outputs an analog signal corresponding to the light signal, an analog-digital conversion circuit that converts the analog signal into digital data and outputs the digital data, and a plurality of memory banks that store the digital data and output the digital data. Each of the plurality of memory banks includes a pre-charge circuit that controls voltage levels of a first output line and a second output line connected to each of the plurality of memory banks based on a pre-charge enable signal.

### CROSS-REFERENCE TO RELATED APPLICATION(S

This U.S. non-provisional application is based on and claims priority under 35 USC § 119 to Korean Patent Application No. 10-2025-0011849, filed on January 24, 2025, in the Korean Intellectual Property Office, the disclosure of which is herein incorporated by reference in its entirety.

### BACKGROUND

The present disclosure relates to an image sensor and a method of operating the same, and more particularly, to an image sensor including digital pixels and a method of operating the same.

An image sensor may convert light into an electrical signal. Related art image sensors operate using analog pixels, which receive the light and output an analog signal, and a separate analog-digital converter, which converts the analog signal into a digital signal.

In contrast, since a digital pixel performs an operation of converting the analog signal into the digital signal in each pixel, the digital signal is output by the digital pixel instead of the analog signal. Digital signals may be less susceptible to the effects of noise and the like compared to analog signals.

Therefore, research on image sensors using digital pixels with low noise and fast readout speed is actively being conducted.

### SUMMARY

The present disclosure is directed to providing a digital pixel and an image sensor capable of outputting digital data stored in a memory in a pixel at high speed.

According to an aspect of the disclosure, there is provided a digital pixel including at least one photodetection circuit configured to receive light and output an analog signal based on the light, an analog-digital conversion circuit configured to convert the analog signal into digital data and output the digital data, and a plurality of memory banks configured to store the digital data and output the digital data, wherein each of the plurality of memory banks includes a pre-charge circuit configured to control a first voltage level of a first output line and a second voltage level of a second output line connected to each of the plurality of memory banks based on a pre-charge enable signal.

Each of the plurality of memory banks may include a plurality of static random access memory (SRAM) cells.

Based on the pre-charge enable signal, the pre-charge circuit may be further configured to: pull up the first voltage level of the first output line and the second voltage level of the second output line to a power supply voltage, or pull down the first voltage level of the first output line and the second voltage level of the second output line to a ground voltage.

The pre-charge circuit may include a first p-type metal-oxide semiconductor (PMOS) transistor having a source node to which a power supply voltage is applied and a drain node electrically connected to each of the plurality of memory banks and the first output line; and a second PMOS transistor having a source node to which the power supply voltage is applied and a drain node electrically connected to each of the plurality of memory banks and the second output line, wherein a gate node of the first PMOS transistor and a gate node of the second PMOS transistor are electrically connected to each other through a common gate node.

Based on the pre-charge enable signal, the pre-charge circuit may be further configured to: receive the pre-charge enable signal through the common gate node, and pull up the first voltage level of the first output line and the second voltage level of the second output line to the power supply voltage.

The pre-charge circuit may include: a first n-type metal-oxide semiconductor (NMOS) transistor having a drain node to which a ground voltage is applied and a source node electrically connected to each of the plurality of memory banks and the first output line; and a second NMOS transistor having a drain node to which the ground voltage is applied and a source node electrically connected to each of the plurality of memory banks and the second output line, wherein a gate node of the first NMOS transistor and a gate node of the second NMOS transistor are electrically connected to each other through a common gate node.

Based on the pre-charge enable signal, the pre-charge circuit may be further configured to: receive the pre-charge enable signal through the common gate node, and pull down the first voltage level of the first output line and the second voltage level of the second output line to the ground voltage.

The at least one photodetection circuit may be provided on a first substrate, the analog-digital conversion circuit and the plurality of memory banks may be provided on a second substrate, and the first substrate may be electrically connected to the second substrate and vertically stacked with the second substrate so that the plurality of memory banks on the second substrate are electrically connected to the at least one photodetection circuit.

According to another aspect of the disclosure, there is provided an image sensor including: a pixel array including a plurality of digital pixels configured to convert light into digital data and output the digital data, a pixel driver configured to control the pixel array, and a digital logic circuit configured to control the pixel driver, receive the digital data from the pixel array, perform digital signal processing, and output the digital data after the digital signal processing, wherein each of the plurality of digital pixels includes: at least one photodetection circuit configured to receive the light and output an analog signal corresponding to the light; an analog-digital conversion circuit configured to convert the analog signal into the digital data and output the digital data; and a plurality of memory banks configured to store the digital data and output the digital data, wherein each of the plurality of memory banks includes a pre-charge circuit configured to control a first voltage level of a first output line and a second voltage level of a second output line connected to each of the plurality of memory banks based on a pre-charge enable signal.

According to another aspect of the disclosure, there is provided a memory bank including: a plurality of static random access memory (SRAM) cells, each of the SRAM cells configured to store data and connected to a first output line and a second output line; and a pre-charge circuit configured to control a first voltage level of the first output line and a second voltage level the second output line based on a pre-charge enable signal.

Based on the pre-charge enable signal, the pre-charge circuit may be further configured to: pull up the first voltage level of the first output line and the second voltage level of the second output line to a power supply voltage, or pull down the first voltage level of the first output line and the second voltage level of the second output line to a ground voltage.

The pre-charge circuit may include: a first p-type metal-oxide semiconductor (PMOS) transistor having a source node to which a power supply voltage is applied and a drain node electrically connected to the memory bank and the first output line; and a second PMOS transistor having a source node to which the power supply voltage is applied and a drain node electrically connected to the memory bank and the second output line, wherein a gate node of the first PMOS transistor and a gate node of the second PMOS transistor are electrically connected to each other through a common gate node.

The pre-charge circuit may include: a first n-type metal-oxide semiconductor (NMOS) transistor having a drain node to which a ground voltage is applied and a source node electrically connected to the memory bank and the first output line; and a second NMOS transistor having a drain node to which the ground voltage is applied and a source node electrically connected to each of the memory bank and the second output line, wherein a gate node of the first NMOS transistor and a gate node of the second NMOS transistor are electrically connected to each other through a common gate node.

According to an embodiment of the disclosure, there is provided a method of operating an image sensor, including: converting, by each of a plurality of digital pixels, a light signal into an analog signal and outputting the analog signal; converting, by an analog-digital converter, the analog signal into digital data and outputting the digital data; storing, by a plurality of memory banks, the digital data; controlling, by a pre-charge circuit, voltage levels of a first output line and a second output line connected to each of the plurality of memory banks; and outputting the digital data stored in the plurality of memory banks through the first output line and the second output line while the voltage levels of the first output line and the second output line are controlled.

Each of the plurality of memory banks may include a plurality of SRAM cells.

The method may further include pulling up, by the pre-charge circuit, the voltage levels of the first output line and the second output line to a power supply voltage.

The method may further include pulling down, by the pre-charge circuit, the voltage levels of the first output line and the second output line to a ground voltage.

### BRIEF DESCRIPTION OF DRAWINGS

The above and other aspects, features, and advantages of the disclosure will be more clearly understood from the following detailed description, taken in conjunction with the accompanying drawings:

FIG. 1 is a diagram for explaining an image sensor according to an embodiment of the present disclosure.

FIG. 2 is a circuit diagram for explaining a photodetection circuit according to an embodiment of the present disclosure.

FIG. 3 is a circuit diagram for explaining a photodetection circuit according to another embodiment of the present disclosure.

FIG. 4 is a diagram for explaining an analog-digital conversion circuit according to an embodiment of the present disclosure.

FIG. 5 is a timing diagram for explaining a count code.

FIG. 6 is a diagram for explaining a plurality of memory banks.

FIG. 7 is a diagram for explaining a readout operation of a comparative example without a pre-charge circuit.

FIG. 8A is a diagram for explaining a conceptual layout of a comparative example in a case in which the number of memory cells is small.

FIG. 8B is a diagram for explaining a conceptual layout of a comparative example in a case in which the number of memory cells is sufficiently large.

FIG. 9 is a diagram for explaining a readout operation of an image sensor.

FIG. 10 is a diagram for explaining an implementation example of the image sensor according to an embodiment of the present disclosure.

FIG. 11 is a flowchart for explaining an operation of the image sensor.

FIG. 12 is a diagram for explaining an imaging device to which the image sensor according to an embodiment of the present disclosure is applied.

### DETAILED DESCRIPTION

Hereinafter, embodiments of the present invention will be described clearly and in detail so that those skilled in the art can easily practice the present invention.

Below, embodiments of the disclosure will be described in detail and clearly to such an extent that an ordinary one in the art easily carries out the disclosure. As used herein, an expression “at least one of” preceding a list of elements modifies the entire list of the elements and does not modify the individual elements of the list. For example, an expression, “at least one of a, b, and c” should be understood as including only a, only b, only c, both a and b, both a and c, both b and c, or all of a, b, and c.

To clearly describe the disclosure, parts that are irrelevant to the description in the drawings are omitted, and like numerals refer to like or similar constituent elements throughout the specification.

Further, since sizes and thicknesses of constituent members shown in the accompanying drawings are arbitrarily given for better understanding and ease of description, the disclosure is not limited to the illustrated sizes and thicknesses.

Throughout this specification and the claims that follow, when it is described that an element is “coupled/connected” to another element, the element may be “directly coupled/connected” to the other element or “indirectly coupled/connected” to the other element through a third element. In addition, unless explicitly described to the contrary, the word “comprise” and variations such as “comprises” or “comprising” will be understood to imply the inclusion of stated elements but not the exclusion of any other elements.

Further, when two or more elements (or components, or layers) are described as being “electrically connected,” these two or more elements may be in a state of electrically connected through a conductive medium such as wire or being configured to be electrically connected through the conductive medium when power is supplied to a device including the two or more elements.

According to one or more embodiments, various operations and/or functions described below may be implemented in a hardware approach. For example, according to some embodiments, the methods described below may be implemented by an electronic device configured to carry out a described operation(s) or function(s). The electronic device may include blocks, which may be referred to herein as managers, units, modules, hardware components, “~er” terms or the like, may be physically implemented by analog and/or digital circuits such as logic gates, integrated circuits, microprocessors, microcontrollers, memory circuits, passive electronic components, active electronic components, optical components, hardwired circuits and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure. However, the disclosure is not limited thereto, and as such, the blocks, which may be referred to herein as managers, units, modules, or the like, may be software modules implemented by software codes, program codes, software instructions, or the like. The software modules may be executed on one or more processors.

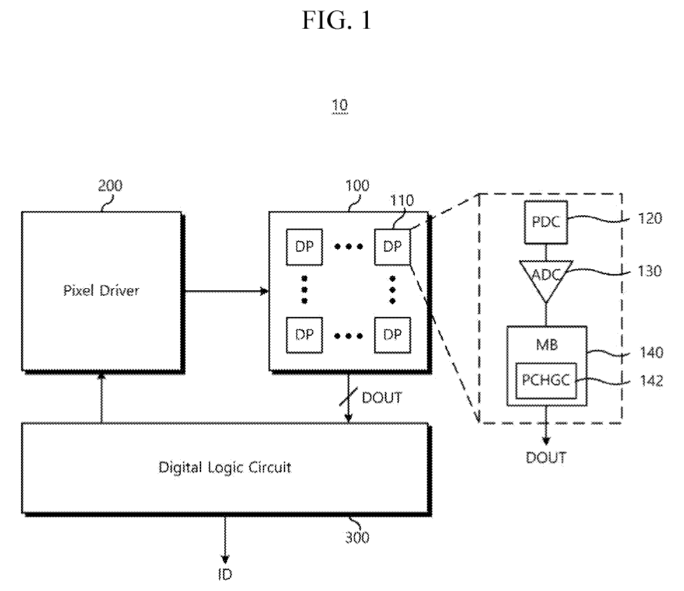

FIG. 1 is a diagram for explaining an image sensor 10 according to an embodiment of the present disclosure.

Referring to FIG. 1, the image sensor 10 may include a pixel array 100, a pixel driver 200, and a digital logic circuit 300.

The pixel array 100 may include a plurality of digital pixels DP. The plurality of digital pixels DP included in the pixel array 100 may be arranged in a matrix form. Each of the digital pixels DP of the pixel array 100 may convert light into a digital output. For example, the light may be referred to as a light signal and the digital output may be referred to as an electronic signal. For example, each of the digital pixels DP of the pixel array 100 may convert the light signal into N-bit (where N is a natural number equal to or greater than 2) digital data DOUT. The pixel array 100 may output the digital data DOUT of each of the digital pixels DP. The digital pixel 110 may include a photodetection circuit (PDC) 120, an analog-digital conversion circuit (ADC) 130, and a plurality of memory banks (MB) 140.

The photodetection circuit 120 may receive the light signal and output an analog signal corresponding to the light signal.

The analog-digital conversion circuit 130 may receive the analog signal output from the photodetection circuit 120, convert the analog signal into the digital data DOUT, and output the digital data DOUT. The analog-digital conversion circuit 130 according to an embodiment of the present disclosure may include a comparator.

The plurality of memory banks 140 may store the digital data DOUT output from the analog-digital conversion circuit 130 and output the digital data DOUT. The plurality of memory banks 140 according to an embodiment may include a plurality of static random access memory (SRAM) cells. However, this is only exemplary, and the plurality of memory banks 140 according to another embodiment may include memory cells other than SRAM.

As described above, the digital pixel 110 may convert the light signal into the digital data DOUT, store the digital data DOUT in the plurality of memory banks 140, and output the digital data DOUT. Therefore, compared to an analog pixel, the time required to read out the stored data or thereafter process the readout data may be reduced.

The pixel driver 200 may control the pixel array 100 based on control by the digital logic circuit 300. For example, the pixel driver 200 may control the pixel array 100 based on one or more control signals output by the digital logic circuit 300.

The pixel driver 200 may include, but is not limited to, a timing controller, a ramp generator, a memory controller, and the like. The timing controller may control the operation or timing of the analog-digital conversion circuit, the ramp generator, a counter controller, and the like. The ramp generator may generate a ramp signal based on the control of the timing controller and provide the generated ramp signal to the analog-digital conversion circuit 130. For example, the ramp generator may be implemented using an integrator. The memory controller may control the plurality of memory banks 140.

However, this is only exemplary, and the pixel driver 200 may further include a row driver, a column driver, the counter controller, and the like for controlling the pixel array 100.

The digital logic circuit 300 may control the pixel driver 200, perform digital signal processing on the digital data DOUT received from the pixel array 100, and output the image data ID after the digital signal processing. The image data ID may be provided to an image signal processor (ISP) or an application processor (AP). The ISP may be located inside the image sensor 10 or located in an external device of the image sensor 10.

The image sensor 10 according to an embodiment of the present disclosure may read out the digital data DOUT stored in the plurality of memory banks 140 of the digital pixel 110 at high speed. For example, the image sensor 10 may operate at high speed by reading out the digital data DOUT in parallel.

For example, the image sensor 10 may process more digital data DOUT in parallel by increasing the number of SRAM cells included in each of the plurality of memory banks 140. In this case, due to the increase in the number of SRAM cells, metal capacitance components based on physical characteristics of metal wiring layers constituting a pair of output lines connected to each of the plurality of memory banks 140 may increase. For example, parasitic capacitance between the plurality of memory banks 140 and the metal wiring layer may increase.

When the metal capacitance components of the pair of output lines increase, in a case in which voltage levels of the pair of output lines differ from voltage levels corresponding to the digital data DOUT stored in the SRAM cell, the digital data DOUT stored in the SRAM cell may be re-written.

According to an embodiment of the disclosure, before reading out the digital data DOUT of the SRAM cell, the image sensor 10 may pre-charge the voltage levels of the pair of output lines to a power supply voltage or a ground voltage using a pre-charge circuit (PCHGC) 142. Therefore, the image sensor 10 may read out the digital data DOUT in parallel without being affected by the increase in the metal capacitance components of the pair of output lines. Therefore, the image sensor 10 may read out the digital data DOUT at high speed. According to an embodiment, the image sensor 10 may be implemented by only adding the pre-charge circuit 142 to the plurality of memory banks 140 without additional configuration or modification of the analog-digital conversion circuit 130. However, the disclosure is not limited thereto.

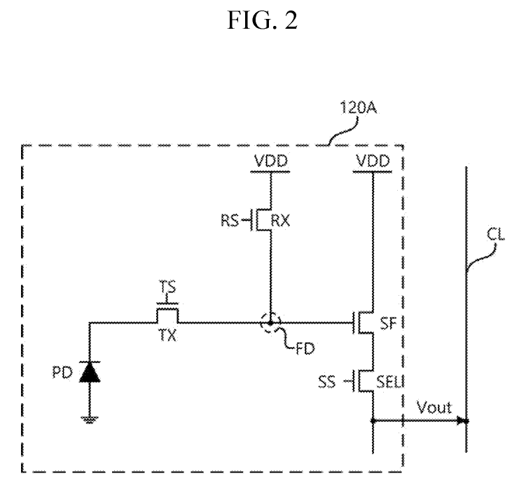

FIG. 2 is a circuit diagram for explaining a photodetection circuit 120A according to an embodiment of the present disclosure.

The photodetection circuit 120A according to an embodiment of the present disclosure may include a photodiode PD, a transfer transistor TX, a source follower transistor SF, a selection transistor SEL, and a reset transistor RX.

The photodiode PD may be exposed to light to generate photocharges and may integrate the generated photocharges.

The transfer transistor TX may control the movement of charge between the photodiode PD and a floating node FD by a transfer control signal TS.

The source follower transistor SF may be referred to as a drive transistor. The source follower transistor SF may provide an analog signal Vout, which is obtained by amplifying a voltage applied to its gate terminal from a voltage of the floating node FD, to one terminal of the selection transistor SEL.

The selection transistor SEL may output the analog signal Vout provided from the source follower transistor SF to a column line CL under the control of a selection signal SS.

The reset transistor RX may connect a reset voltage power supply VDD to the floating node FD, and may reset the floating node FD by a reset control signal RS.

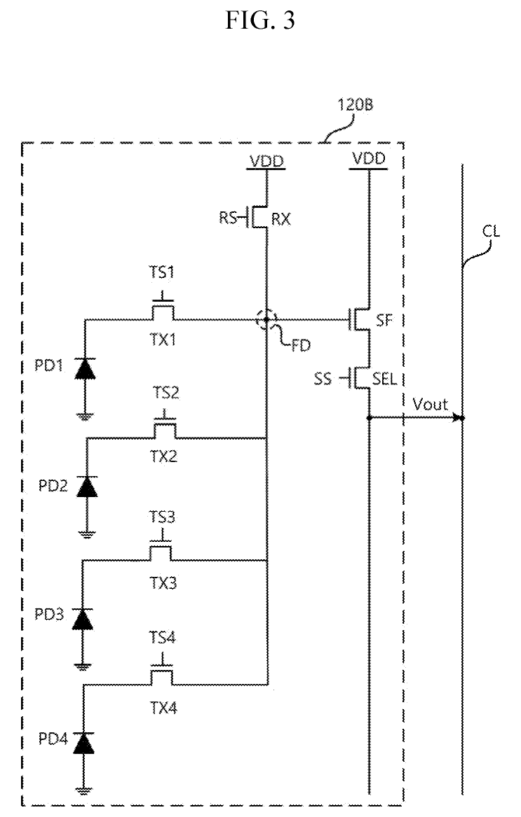

FIG. 3 is a circuit diagram for explaining a photodetection circuit 120B according to another embodiment of the present disclosure.

Photodiodes PD1, PD2, PD3, and PD4 of the photodetection circuit 120B according to an embodiment of the present disclosure may share at least one transistor.

The photodiodes PD1, PD2, PD3, and PD4 of the photodetection circuit 120B according to the embodiment of FIG. 3 may share a selection transistor SEL, a source follower transistor SF, and a reset transistor RX. Photocharges of each of the photodiodes PD1, PD2, PD3, and PD4 may be transferred to a floating node FD by each of transfer transistors TX1, TX2, TX3, and TX4. Each of the transfer transistors TX1, TX2, TX3, and TX4 may be controlled by each of transfer control signals TS1, TS2, TS3, and TS4.

In an embodiment, each of the transfer transistors TX1, TX2, TX3, and TX4 may be turned on at a different time, and each of the photodiodes PD1, PD2, PD3, and PD4 may individually output its corresponding analog signal Vout to a column line CL one by one.

In an embodiment, each of the transfer transistors TX1, TX2, TX3, and TX4 may be turned on at the same time, and all of the photodiodes PD1, PD2, PD3, and PD4 may simultaneously transfer photocharges to the floating node FD. The source follower transistor SF may output the analog signal Vout based on a voltage of the floating node FD to which the photocharges from all of the photodiodes PD1, PD2, PD3, and PD4 are transferred.

However, FIGS. 2 and 3 are only exemplary implementations of the photodetection circuit 120 according to embodiments of the present disclosure, and the implementations of the photodetection circuit 120 are not limited to those shown in FIGS. 2 and 3.

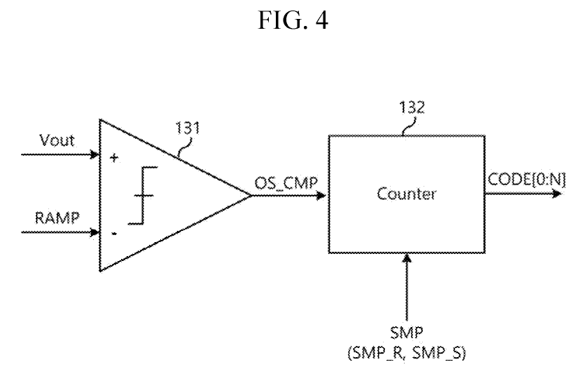

FIG. 4 is a diagram for explaining the analog-digital conversion circuit 130 according to an embodiment of the present disclosure.

Referring to FIG. 4, the analog-digital conversion circuit 130 may include a comparator 131 and a counter 132.

The comparator 131 may compare an analog signal Vout and a ramp signal RAMP and output a comparison result signal OS_CMP to the counter 132.

The analog signal Vout may be provided from the photodetection circuit 120. The analog signal Vout may be a signal based on a voltage level corresponding to the light (e.g., a light signal).

The ramp signal RAMP may be provided from the pixel driver 200. The ramp signal RAMP may be a signal having a voltage level that decreases or increases with a constant slope in at least a portion of an interval. Hereinafter, the ramp signal RAMP will be described on the assumption that the ramp signal RAMP is a signal having a voltage level that decreases with a constant slope. However, but this is only exemplary, and as such, the disclosure is not limited thereto. Accordingly, the ramp signal RAMP may have a different configuration.

The comparator 131 may be implemented as an operational amplifier that receives the analog signal Vout through a positive polarity (+) input terminal and receives the ramp signal RAMP through a negative polarity (-) input terminal. The polarities of the input terminals are only exemplary. The comparator 131 may change a level of the comparison result signal OS_CMP to another level when the voltage level of the ramp signal RAMP reaches a voltage level of the analog signal Vout. In addition, the comparison result signal OS_CMP may be provided to the counter 132.

The counter 132 may receive the comparison result signal OS_CMP, and generate and output a count code CODE[0:N] based on a sampling signal SMP.

The sampling signal SMP may be provided from the pixel driver 200. The sampling signal SMP may be a first sampling signal SMP_R or a second sampling signal SMP_S. The first sampling signal SMP_R may be a signal for generating the count code CODE[0:N] corresponding to a reset level of the analog signal Vout. The second sampling signal SMP_S may be a signal for generating the count code CODE[0:N] corresponding to a signal level of the analog signal Vout. The image sensor 10 may perform a correlated double sampling (CDS) operation using the count code CODE[0:N] corresponding to each of the reset level and the signal level of the analog signal Vout.

The count code CODE[0:N] may include a plurality of count codes (CODE[0], CODE[1], …, and CODE[N]). The count code CODE[0:N] may be a signal obtained by converting the analog signal Vout into a digital signal.

As described above, the analog-digital conversion circuit 130 may generate the comparison result signal OS_CMP by comparing the analog signal Vout with the ramp signal RAMP. In addition, the analog-digital conversion circuit 130 may generate and output the count code CODE[0:N], which is digital data, based on the comparison result signal OS_CMP and the sampling signal SMP.

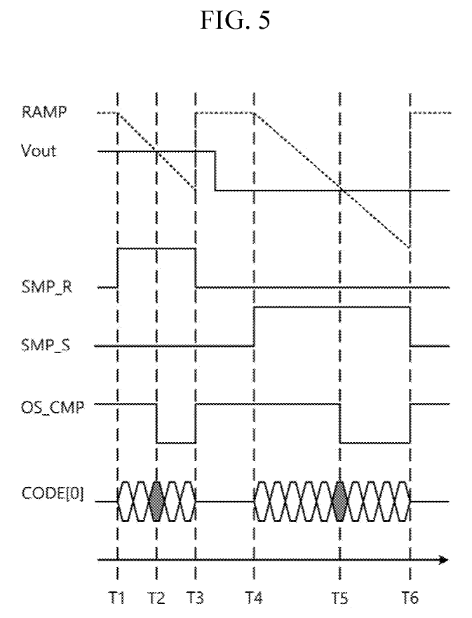

FIG. 5 is a timing diagram for explaining the count code CODE. Descriptions that are redundant or similar to the contents of FIGS. 1 to 4 will be omitted hereinafter.

In FIG. 5, before time T1, the photodetection circuit 120 may generate and output the analog signal Vout. Thereafter, from time T1 to time T3, a voltage level of the ramp signal RAMP may decrease with a constant slope. At this time, the first sampling signal SMP_R may be activated to have a high level from time T1 to time T3. Therefore, the time period from time T1 to time T3 may be a time period during which reset level sampling is performed. From time T1, the voltage level of the ramp signal RAMP may change, and simultaneously, a counting operation of the counter 132 may start.

At time T2, the voltage level of the ramp signal RAMP reaches the analog signal Vout, and from time T2 to time T3, the voltage level of the ramp signal RAMP may be lower than that of the analog signal Vout. Therefore, at time T2, the comparison result signal OS_CMP may change from logic high to logic low. For example, the values of the count code CODE at time T2 when a level of the comparison result signal OS_CMP is switched during the time period when the first sampling signal SMP_R is activated may be output by the counter 132 as each bit of a reset count code.

At time T3, the voltage level of the ramp signal RAMP may change back to an initial level, and the level of the comparison result signal OS_CMP may also change back to an initial level. After time T3 and before time T4, the photodetection circuit 120 may generate and output the next analog signal Vout. Thereafter, from time T4 to time T6, the voltage level of the ramp signal RAMP may decrease with a constant slope. At this time, the second sampling signal SMP_S may be activated to have a high level from time T4 to time T6. Therefore, the time period from time T4 to time T6 may be a time period during which signal level sampling is performed. From time T4, the voltage level of the ramp signal RAMP may change again, and simultaneously, the counting operation of the counter 132 may start again.

At time T5, the voltage level of the ramp signal RAMP reaches the analog signal Vout, and from time T5 to time T6, the voltage level of the ramp signal RAMP may be lower than that of the analog signal Vout. Therefore, at time T5, the comparison result signal OS_CMP may change from logic high to logic low. For example, the values of the count code CODE at time T5 when the level of the comparison result signal OS_CMP is switched during the time period when the second sampling signal SMP_S is activated may be output by the counter 132 as each bit of a signal count code. As described above, the count code CODE may be the same data as the digital data DOUT.

Thereafter, under the control of the pixel driver 200, each of the reset count code and the signal count code may be output to the plurality of memory banks 140 of FIG. 1.

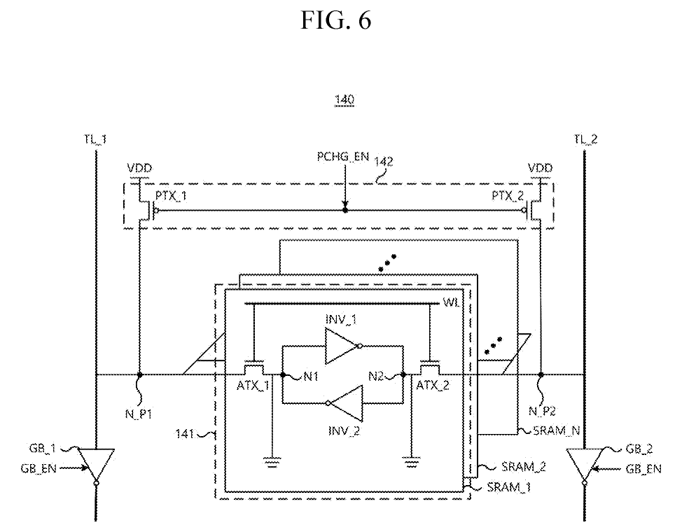

FIG. 6 is a diagram for explaining the plurality of memory banks 140.

Referring to FIG. 6, the plurality of memory banks 140 may include a SRAM cell 141 and a pre-charge circuit 142. FIG. 6 illustrates an example of one memory bank among the plurality of memory banks 140. In addition, each of the plurality of memory banks 140 may include a plurality of SRAM cells (SRAM_1, SRAM_2, …, and SRAM_N), and FIG. 6 illustrates an example of one SRAM cell 141 among the plurality of SRAM cells.

The SRAM cell 141 may include a first access transistor ATX_1, a second access transistor ATX_2, a first inverter INV_1, a second inverter INV_2, a first storage node N1, and a second storage node N2. Each of the SRAM cells (SRAM_2, …, and SRAM_N) may have the same configuration as the SRAM cell (SRAM_1) 141.

The first access transistor ATX_1 may electrically connect the first storage node N1 and a first output line TL_1 to each other. In an example case in which a word line WL of the SRAM cell 141 is activated to read out or write data, the first access transistor ATX_1 may be turned on and connect the first storage node N1 to the first output line TL_1.

The second access transistor ATX_2 may electrically connect the second storage node N2 and a second output line TL_2 to each other. In an example case in which the word line WL of the SRAM cell 141 is activated to read out or write data, the second access transistor ATX_2 may be turned on and connect the second storage node N2 to the second output line TL_2.

An input terminal of the first inverter INV_1 may be electrically connected to the first storage node N1, and an output terminal of the first inverter INV_1 may be electrically connected to the second storage node N2. The first inverter INV_1 may invert data stored in the first storage node N1 and output the inverted data to the second storage node N2. The first inverter INV_1 may include a p-type metal-oxide semiconductor (PMOS) transistor and an n-type metal-oxide semiconductor (NMOS) transistor.

An input terminal of the second inverter INV_2 may be electrically connected to the second storage node N2 and an output terminal of the second inverter INV_2 may be electrically connected to the first storage node N1. The second inverter INV_2 may invert data stored in the second storage node N2 and output the inverted data to the first storage node N1. The second inverter INV_2 may include a PMOS transistor and an NMOS transistor.

That is, the output data of the first inverter INV_1 may be provided as the input data of the second inverter INV_2. Conversely, the output data of the second inverter INV_2 may be provided as the input data of the first inverter INV_1. Therefore, each of the first inverter INV_1 and the second inverter INV_2 may stably maintain its data. This characteristic may be referred to as an "SRAM latch operation."

In an example case in which the first inverter INV_1 outputs a bit '1', the second inverter INV_2 may output a bit '0'. In this case, since the bit '0', which is the output data of the second inverter (INV_2), is provided again as the input data of the first inverter INV_1, the output data of the first inverter INV_1 and the second inverter INV_2 may be stably maintained as bit '0' or '1'.

In an example case in which the image sensor 10 performs a CDS operation, the SRAM cell may include a first memory cell group and a second memory cell group. In this case, the first memory cell group may store data corresponding to a reset level value. In addition, the second memory cell group may store data corresponding to a signal level value.

The plurality of memory banks 140 according to an embodiment of the present disclosure may include a first global buffer GB_1 and a second global buffer GB_2.

The first global buffer GB_1 may be electrically connected to the first output line TL_1. The first global buffer GB_1 may output the data stored in the first storage node N1 through the first output line TL_1 based on a global buffer enable signal GB_EN.

For example, the first global buffer GB_1 may temporarily store the data stored in the first storage node N1. In this case, when the global buffer enable signal GB_EN is at a high level, the first global buffer GB_1 may output the data stored in the first storage node N1 through the first output line TL_1.

The second global buffer GB_2 may be electrically connected to the second output line TL_2. The second global buffer GB_2 may output the data stored in the second storage node N2 through the second output line TL_2 based on the global buffer enable signal GB_EN.

For example, the second global buffer GB_2 may temporarily store the data stored in the second storage node N2. In this case, when the global buffer enable signal GB_EN is high, the second global buffer GB_2 may output the data stored in the second storage node N2 through the second output line TL_2.

The pre-charge circuit 142 may include a first pre-charge transistor PTX_1 and a second pre-charge transistor PTX_2. The first pre-charge transistor PTX_1 and the second pre-charge transistor PTX_2 may be p-type metal-oxide semiconductor (PMOS) transistors.

A power supply voltage VDD may be applied to a source node of the first pre-charge transistor PTX_1, and a drain node of the first pre-charge transistor PTX_1 may be electrically connected to a first pre-charge node N_P1. The power supply voltage VDD may be applied to a source node of the second pre-charge transistor PTX_2, and a drain node of the second pre-charge transistor PTX_2 may be electrically connected to a second pre-charge node N_P2. In addition, a gate node of the first pre-charge transistor PTX_1 may be electrically connected to a gate node of the second pre-charge transistor PTX_2 through a common gate node.

The pre-charge circuit 142 may receive a pre-charge enable signal PCHG_EN through the common gate node before outputting the data stored in the SRAM cell 141. In an example case in which the pre-charge circuit 142 receives the pre-charge enable signal PCHG_EN, voltage levels of the first pre-charge node N_P1 and the second pre-charge node N_P2 may be pulled up to the power supply voltage VDD. As a result, voltage levels of the first output line TL_1 and the second output line TL_2 may be pulled up to the power supply voltage VDD.

However, the illustration in FIG. 6 is exemplary, and the first pre-charge transistor PTX_1 and the second pre-charge transistor PTX_2 may be n-type metal-oxide semiconductor (NMOS) transistors. In this case, a ground voltage VSS may be applied to the drain node of the first pre-charge transistor PTX_1, and the source node of the first pre-charge transistor PTX_1 may be electrically connected to the first pre-charge node N_P1. The ground voltage VSS may be applied to the drain node of the second pre-charge transistor PTX_2, and the source node of the second pre-charge transistor PTX_2 may be electrically connected to the second pre-charge node N_P2. In addition, the gate node of the first pre-charge transistor PTX_1 may be electrically connected to the gate node of the second pre-charge transistor PTX_2.

The pre-charge circuit 142 may receive the pre-charge enable signal PCHG_EN before reading out the data stored in the SRAM cell 141. In an example case in which the pre-charge circuit 142 receives the pre-charge enable signal PCHG_EN, the voltage levels of the first pre-charge node N_P1 and the second pre-charge node N_P2 may be pulled down to the ground voltage VSS. As a result, the voltage levels of the first output line TL_1 and the second output line TL_2 may be pulled down to the ground voltage VSS.

Hereinafter, the following description may be based on the assumption that the first pre-charge transistor PTX_1 and the second pre-charge transistor PTX_2 constituting the pre-charge circuit 142 are PMOS transistors. However, the disclosure is not limited thereto.

As described above, the pre-charge circuit 142 may pre-charge the voltage levels of the first output line TL_1 and the second output line TL_2 before reading out the data stored in the SRAM cell 141. In this case, it is possible to prevent problems caused by an increase in metal capacitance values of the output lines due to an increase in the number of SRAM cells for high-speed operation. For example, due to the increase in the metal capacitance values of the output lines, a phenomenon in which the data of the SRAM cell is re-written by the voltage levels of the output lines may be prevented.

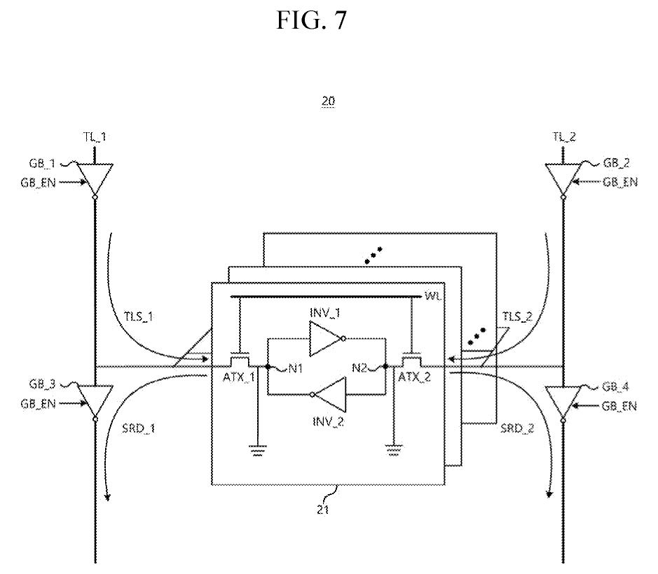

FIG. 7 is a diagram for explaining a readout operation of a comparative example 20 without a pre-charge circuit 142. Hereinafter, a readout operation of one memory cell 21 will be described with reference to FIG. 7.

A first output line signal TLS_1 may be provided from a first global buffer GB_1. The first output line signal TLS_1 may be provided to the memory cell 21 through a first output line TL_1. The first output line signal TLS_1 may be a signal having data of bit ‘0’ or ‘1’ as a voltage level. The first output line signal TLS_1 may be a signal provided for reading out data stored in a first storage node N1.

A second output line signal TLS_2 may be provided from a second global buffer GB_2. The second output line signal TLS_2 may be provided to the memory cell 21 through a second output line TL_2. The second output line signal TLS_2 may be a signal having data of bit ‘0’ or ‘1’ as a voltage level. The second output line signal TLS_2 may be a signal provided for reading out data stored in a second storage node N2.

The first output line signal TLS_1 and the second output line signal TLS_2 may be signals having data complementary to each other. In an example case in which the data of the first output line signal TLS_1 is bit ‘0’, the data of the second output line signal TLS_2 may be bit ‘1’. Conversely, in an example case in which the data of the first output line signal TLS_1 is bit ‘1’, the data of the second output line signal TLS_2 may be bit ‘0’.

The memory cell 21 may output a first stored data SRD_1 and a second stored data SRD_2 based on the first output line signal TLS_1 and the second output line signal TLS_2 through a third global buffer GB_3 and a fourth global buffer GB_4.

Hereinafter, the readout operation of the comparative example 20 will be described assuming a case in which bit ‘1’ is stored in the first storage node N1 and bit ‘0’ is stored in the second storage node N2.

For example, based on a global buffer enable signal GB_EN, the first global buffer GB_1 may output bit ‘1’ as the data of the first output line signal TLS_1, and the second global buffer GB_2 may output bit ‘0’ as the data of the second output line signal TLS_2.

In this case, since the data of the first output line signal TLS_1 and the data stored in the first storage node N1 are the same as bit ‘1’, bit ‘1’ may be output as the first stored data SRD_1. In addition, since the data of the second output line signal TLS_2 and the data stored in the second storage node N2 are the same as bit ‘0’, bit ‘0’ may be output as the second stored data SRD_2.

In another example, based on the global buffer enable signal GB_EN, the first global buffer GB_1 may output bit ‘0’ as the data of the first output line signal TLS_1, and the second global buffer GB_2 may output bit ‘1’ as the data of the second output line signal TLS_2.

In this case, the data of the first output line signal TLS_1 differs from the data stored in the first storage node N1. Therefore, the data of the first output line signal TLS_1 may be converted from bit ‘0’ to bit ‘1’ based on bit ‘1’ being the data stored in the first storage node N1, and bit ‘1’ needs to be read out as the first stored data SRD_1. In addition, the data of the second output line signal TLS_2 may be converted from bit ‘1’ to bit ‘0’ based on bit ‘0’ being the data stored in the second storage node N2, and bit ‘0’ needs to be read out as the second stored data SRD_2.

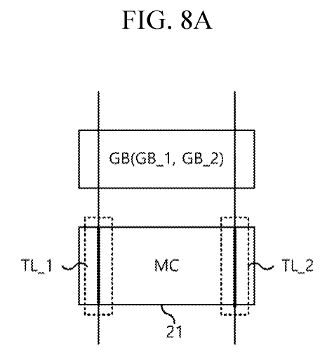

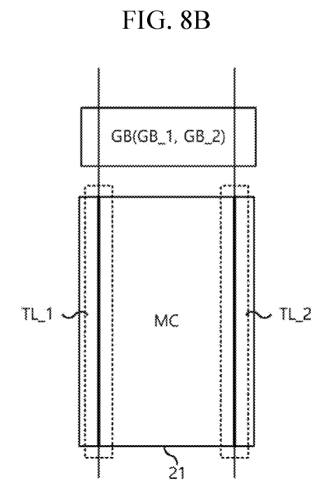

FIG. 8A is a diagram for explaining a conceptual layout of the comparative example 20 in a case in which the number of memory cells is small.

Referring to FIG. 8A, the first output line TL_1 and the second output line TL_2 may be implemented as metal wiring layers electrically connected over the memory cell 21. In this case, when viewed from a direction perpendicular to a plane of a substrate, since areas of the metal wiring layers overlapping the memory cell 21 are not large, influence of the metal wiring layers of the first output line TL_1 and the second output line TL_2 may not be significant. For example, metal capacitance values based on physical characteristics of the metal wiring layers constituting the first output line TL_1 and the second output line TL_2 may not be large.

As a result, in the case of FIG. 8A, in the example of FIG. 7, the data stored in the first storage node N1 and the data stored in the second storage node N2 may be read out as the first stored data SRD_1 and the second stored data SRD_2 without being re-written.

FIG. 8B is a diagram for explaining a conceptual layout of the comparative example 20 in a case in which the number of memory cells is sufficiently large.

Referring to FIG. 8B, when viewed from the direction perpendicular to the plane of the substrate, since the areas of the metal wiring layers overlapping the memory cell 21 are sufficiently large, the influence of the metal wiring layers of the first output line TL_1 and the second output line TL_2 may be significant. For example, the metal capacitance values based on the physical characteristics of the metal wiring layers constituting the first output line TL_1 and the second output line TL_2 may be large.

In an example case illustrated in FIG. 7, when the data stored in the first storage node N1 and the data stored in the second storage node N2 differ from the data of the first output line signal TLS_1 and the second output line signal TLS_2, respectively, the first stored data SRD_1 and the second stored data SRD_2 may be re-written.

As described above, in the case of the comparative example 20, a normal readout operation of the data stored in the SRAM cell may become difficult due to an increase in the number of SRAM cells. In addition, the stored data may even be re-written.

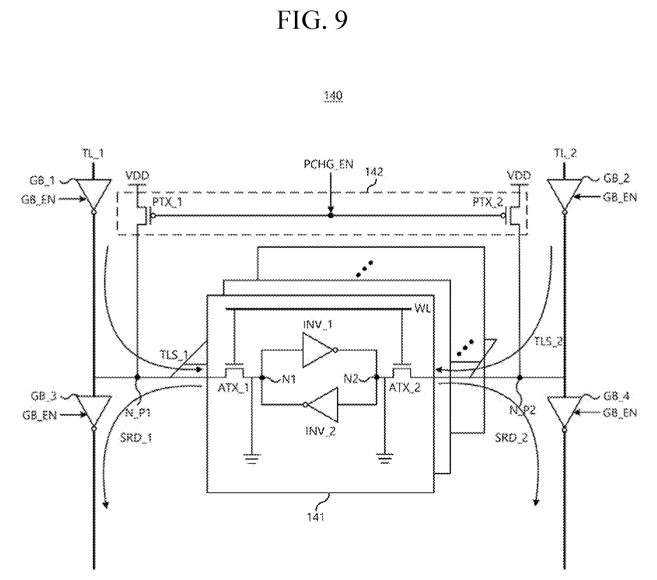

FIG. 9 is a diagram for explaining a readout operation of the image sensor 10. Hereinafter, a readout operation of one SRAM cell 141 among the plurality of memory banks 140 will be described with reference to FIG. 9. Descriptions similar to or redundant with those referring to FIG. 7 will be omitted hereinafter.

Referring to FIG. 9, the pre-charge circuit 142 may be controlled based on the pre-charge enable signal PCHG_EN before the readout operation. For example, the pre-charge circuit 142 may receive the pre-charge enable signal PCHG_EN through the gate nodes of the first pre-charge transistor PTX_1 and the second pre-charge transistor PTX_2. The pre-charge enable signal PCHG_EN may be a signal that lowers gate node voltages of the first pre-charge transistor PTX_1 and the second pre-charge transistor PTX_2.

As a result, when receiving the pre-charge enable signal PCHG_EN, the first pre-charge transistor PTX_1 and the second pre-charge transistor PTX_2 may be turned on to pull up voltage levels of the first pre-charge node N_P1 and the second pre-charge node N_P2 to the power supply voltage VDD. In this case, a voltage level of the power supply voltage VDD may correspond to data of bit ‘1’.

In this case, regardless of the outputs of the first global buffer GB_1 and the second global buffer GB_2, the first output line signal TLS_1 and the second output line signal TLS_2 may have data of bit ‘1’ by the pre-charge circuit 142 before the readout operation.

In the case of the above-described comparative example 20, when the data (bit ‘0’) of the first output line signal TLS_1 and the data (bit ‘1’) of the second output line signal TLS_2 (bit ‘1’) differ from the data (bit ‘1’) stored in the first storage node N1 and the data (bit ‘0’) stored in the second storage node N2, respectively, the normal readout operation may not be performed.

However, in the image sensor 10 according to the embodiment of the present disclosure, the first output line signal TLS_1 and the second output line signal TLS_2 may have data of bit ‘1’ based on the pre-charge circuit 142 before the readout operation. In this case, since the data of the first output line signal TLS_1 and the data stored in the first storage node N1 are the same as bit ‘1’, bit ‘1’ may be output as the first stored data SRD_1. In addition, bit ‘0’ may be output as the second stored data SRD_2 by the above-described “SRAM latch operation” in FIG. 6. In addition, the digital data DOUT may be determined based on the first stored data SRD_1 and the second stored data SRD_2.

As described above, the image sensor 10 may minimize effects caused by the increase in the number of SRAM cells during the readout operation of the data stored in the SRAM cells by using the pre-charge circuit 142. Therefore, the image sensor 10 may perform the normal readout operation at high speed even when designed to have the layout of FIG. 8B.

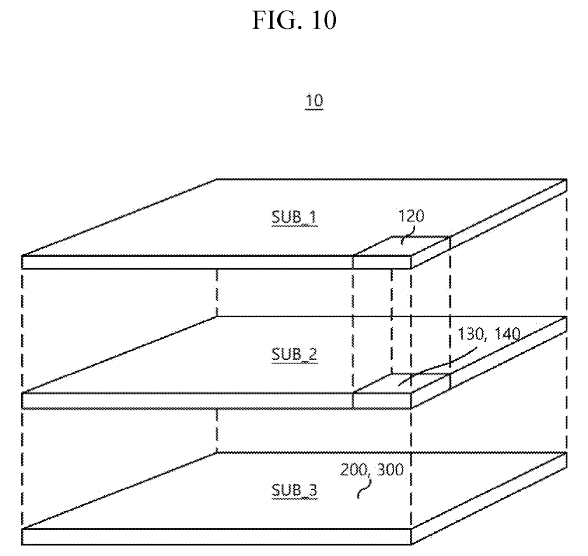

FIG. 10 is a diagram for explaining an implementation example of the image sensor 10 according to an embodiment of the present disclosure.

Referring to FIG. 10, the image sensor 10 may be implemented with a stacked structure. For example, the image sensor 10 may be implemented in a stacked structure using three semiconductor substrates SUB_1, SUB_2, and SUB_3.

A plurality of photodetection circuits 120 may be provided on the first semiconductor substrate SUB_1.

The second semiconductor substrate SUB_2 may be vertically stacked with the first semiconductor substrate SUB_1. The second semiconductor substrate SUB_2 may be electrically connected to the first semiconductor substrate SUB_1. A plurality of analog-digital conversion circuits 130 and a plurality of memory banks 140 may be provided on the second semiconductor substrate SUB_2. In each digital pixel DP constituting the pixel array 100, the analog-digital conversion circuit 130 and the plurality of memory banks 140 corresponding to the photodetection circuit 120 constituting the digital pixel DP may be vertically aligned and provided below the photodetection circuit 120.

The third semiconductor substrate SUB_3 may be vertically stacked with the second semiconductor substrate SUB_2. The third semiconductor substrate SUB_3 may be electrically connected to the first semiconductor substrate SUB_1 and the second semiconductor substrate SUB_2. The pixel driver 200 and the digital logic circuit 300 may be provided on the third semiconductor substrate SUB_3. In an example case in which the digital logic circuit 300 includes a CDS logic circuit, the CDS logic circuit may be provided on the second semiconductor substrate SUB_2 rather than on the third semiconductor substrate SUB_3 depending on the embodiment.

However, the implementation example of the image sensor 10 with reference to FIG. 10 is only exemplary, and the image sensor 10 may be implemented with a stacked structure having more or fewer than three substrates, and may be implemented differently from the arrangement described above with reference to FIG. 10.

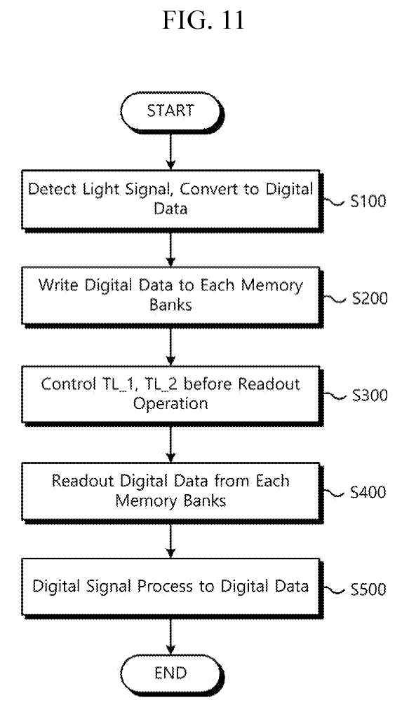

FIG. 11 is a flowchart for explaining an operation of the image sensor 10.

Referring to FIG. 11, in operation S100, the photodetection circuit 120 may receive a light signal and convert the light signal into an analog signal, and the analog-digital conversion circuit 130 may convert the analog signal into digital data DOUT and output the digital data DOUT.

In operation S200, the digital data DOUT may be written to the plurality of memory banks 140. In other words, the digital data DOUT may be stored in the plurality of memory banks 140. Operation S200 may correspond to a write operation of the digital pixel DP.

In operation S300, the pre-charge circuit 142 may control the first output line TL_1 and the second output line TL_2. For example, before the readout operation of the digital pixel DP, the pre-charge circuit 142 may control the voltage levels of the first output line signal TLS_1 and the second output line signal TLS_2 to bit ‘1’ or bit ‘0’ based on the pre-charge enable signal PCHG_EN.

In operation S400, the digital data DOUT stored in the plurality of memory banks 140 may be output. For example, the digital data DOUT may be determined based on the first stored data SRD_1 and the second stored data SRD_2. Operation S400 may correspond to a readout operation of the digital pixel DP.

In operation S500, the digital logic circuit 300 may perform digital signal processing on the digital data DOUT to output the image data ID. For example, the digital logic circuit 300 may perform a CDS operation on the digital data DOUT.

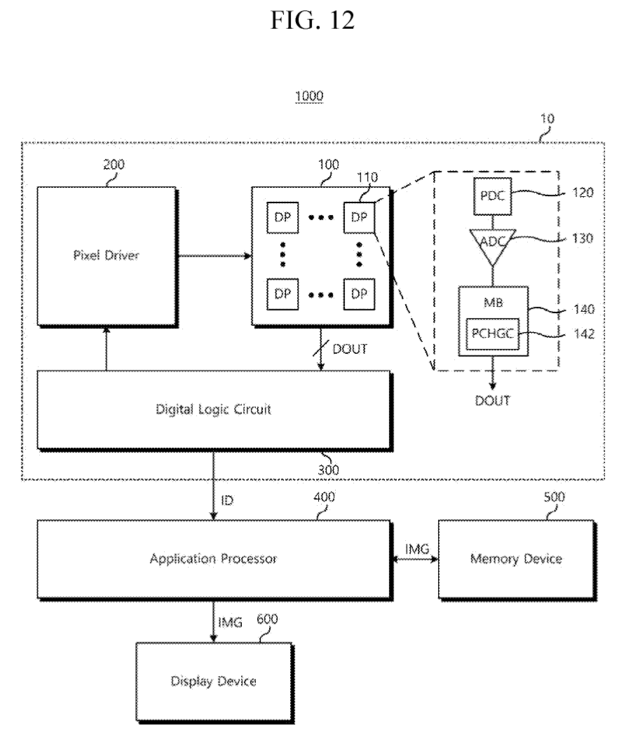

FIG. 12 is a diagram for explaining an imaging device 1000 including the image sensor 10 according to an embodiment of the present disclosure. Descriptions similar to or redundant with those of FIGS. 1 to 11 will be omitted hereinafter.

Referring to FIG. 12, an imaging device 1000 may include the image sensor 10, an application processor 400, a memory device 500, and a display device 600.

The image sensor 10 may receive a light signal, convert the light signal into the digital data DOUT, perform digital signal processing on the digital data DOUT, and output the image data ID.

The application processor 400 may control the image sensor 10 and/or the memory device 500. For example, the application processor 400 may support various applications such as user applications, personal computer (PC) applications, mobile applications, and the like. The application processor 400 may control the image sensor 10 and the memory device 500 according to a user request and/or an application request.

The application processor 400 may receive the image data ID from the image sensor 10, perform image signal processing on the image data ID, and output a final image IMG. For example, the application processor 400 may perform image processing such as artifact removal, noise reduction, white balance, color correction, and sharpening on the image data ID.

The application processor 400 may temporarily or permanently store the image data ID in the memory device 500 during the image signal processing. The application processor 400 may output the final image IMG to the memory device 500 and/or the display device 600.

The memory device 500 may temporarily or permanently store the image data ID and/or the final image IMG. The memory device 500 may be a volatile memory such as a dynamic random access memory (DRAM), a static random access memory (SRAM), or a video random access memory (VRAM), or a non-volatile memory such as a flash memory, a ferroelectric random access memory (FRAM), or a magnetoresistive random access memory (MRAM).

The display device 600 may display the final image IMG. The display device 600 may include a digital camera, a digital camcorder, a mobile phone, a tablet computer, a laptop computer, a portable telephone, a smartphone, a tablet PC, a personal digital assistant (PDA), an enterprise digital assistant (EDA), a digital still camera, a digital video camera, an audio device, a portable multimedia player (PMP), a personal navigation device (PND), an MP3 player, a handheld game console, an e-book, a wearable device, and the like.

A digital pixel and an image sensor according to the present disclosure can output data at high speed by performing a pre-charge operation before outputting the data stored in a memory in the digital pixel.

According to one or more embodiments, there is provided a method of operating an image sensor, which may correspond to the above-described image sensor 10. The method may include: converting, by each of a plurality of digital pixels, a light signal into an analog signal and outputting the analog signal; converting, by an analog-digital converter, the analog signal into digital data and outputting the digital data; storing, by a plurality of memory banks, the digital data; controlling, by a pre-charge circuit, voltage levels of a first output line and a second output line connected to each of the plurality of memory banks; and outputting the digital data stored in the plurality of memory banks through the first output line and the second output line while the voltage levels of the first output line and the second output line are controlled.

According to one or more embodiments, the method may further include pulling up, by the pre-charge circuit, the voltage levels of the first output line and the second output line to a power supply voltage.

According to one or more embodiments, the method may further include pulling down, by the pre-charge circuit, the voltage levels of the first output line and the second output line to a ground voltage.

Meanwhile, the above-described contents are specific embodiments for implementing the present invention. In addition to the above-described embodiments, the present invention will also include embodiments that can be simply designed around or easily changed. In addition, the present invention will also include technologies that can be easily modified and implemented using the embodiments. Therefore, the scope of the present invention should not be limited to the above-described embodiments, but should be defined not only by the patent claims described below but also by the equivalents of the claims of this invention.

What is claimed is:

1. A digital pixel comprising:
at least one photodetection circuit configured to receive light and output an analog signal based on the light;
an analog-digital conversion circuit configured to convert the analog signal into digital data and output the digital data; and
a plurality of memory banks configured to store the digital data and output the digital data,
wherein each of the plurality of memory banks comprises a pre-charge circuit configured to control a first voltage level of a first output line and a second voltage level of a second output line connected to each of the plurality of memory banks based on a pre-charge enable signal.

2. The digital pixel of claim 1, wherein each of the plurality of memory banks comprises a plurality of static random access memory (SRAM) cells.

3. The digital pixel of claim 1, wherein, based on the pre-charge enable signal, the pre-charge circuit is further configured to:
pull up the first voltage level of the first output line and the second voltage level of the second output line to a power supply voltage, or
pull down the first voltage level of the first output line and the second voltage level of the second output line to a ground voltage.

4. The digital pixel of claim 1, wherein the pre-charge circuit comprises:
a first p-type metal-oxide semiconductor (PMOS) transistor having a source node to which a power supply voltage is applied and a drain node electrically connected to each of the plurality of memory banks and the first output line; and
a second PMOS transistor having a source node to which the power supply voltage is applied and a drain node electrically connected to each of the plurality of memory banks and the second output line,
wherein a gate node of the first PMOS transistor and a gate node of the second PMOS transistor are electrically connected to each other through a common gate node.

5. The digital pixel of claim 4, wherein, based on the pre-charge enable signal, the pre-charge circuit is further configured to:
receive the pre-charge enable signal through the common gate node, and
pull up the first voltage level of the first output line and the second voltage level of the second output line to the power supply voltage.

6. The digital pixel of claim 1, wherein the pre-charge circuit comprises:
a first n-type metal-oxide semiconductor (NMOS) transistor having a drain node to which a ground voltage is applied and a source node electrically connected to each of the plurality of memory banks and the first output line; and
a second NMOS transistor having a drain node to which the ground voltage is applied and a source node electrically connected to each of the plurality of memory banks and the second output line,
wherein a gate node of the first NMOS transistor and a gate node of the second NMOS transistor are electrically connected to each other through a common gate node.

7. The digital pixel of claim 6, wherein, based on the pre-charge enable signal, the pre-charge circuit is further configured to:
receive the pre-charge enable signal through the common gate node, and
pull down the first voltage level of the first output line and the second voltage level of the second output line to the ground voltage.

8. The digital pixel of claim 1, wherein the at least one photodetection circuit is provided on a first substrate, and the analog-digital conversion circuit and the plurality of memory banks are provided on a second substrate, and
wherein the first substrate is electrically connected to the second substrate and vertically stacked with the second substrate so that the plurality of memory banks on the second substrate are electrically connected to the at least one photodetection circuit.

9. An image sensor, comprising:
a pixel array comprising a plurality of digital pixels configured to convert light into digital data and output the digital data;
a pixel driver configured to control the pixel array; and
a digital logic circuit configured to control the pixel driver, receive the digital data from the pixel array, perform digital signal processing, and output the digital data after the digital signal processing,
wherein
each of the plurality of digital pixels comprises:
at least one photodetection circuit configured to receive the light and output an analog signal corresponding to the light;
an analog-digital conversion circuit configured to convert the analog signal into the digital data and output the digital data; and
a plurality of memory banks configured to store the digital data and output the digital data,
wherein each of the plurality of memory banks comprises a pre-charge circuit configured to control a first voltage level of a first output line and a second voltage level of a second output line connected to each of the plurality of memory banks based on a pre-charge enable signal.

10. The image sensor of claim 9, wherein each of the plurality of memory banks comprises a plurality of static random access memory (SRAM) cells.

11. The image sensor of claim 9, wherein, based on the pre-charge enable signal, the pre-charge circuit is further configured to:
pull up the first voltage level of the first output line and the second voltage level of the second output line to a power supply voltage, or
pull down the first voltage level of the first output line and the second voltage level of the second output line to a ground voltage.

12. The image sensor of claim 9, wherein the pre-charge circuit comprises:
a first p-type metal-oxide semiconductor (PMOS) transistor having a source node to which a power supply voltage is applied and a drain node electrically connected to each of the plurality of memory banks and the first output line; and
a second PMOS transistor having a source node to which the power supply voltage is applied and a drain node electrically connected to each of the plurality of memory banks and the second output line,
wherein a gate node of the first PMOS transistor and a gate node of the second PMOS transistor are electrically connected to each other through a common gate node.

13. The image sensor of claim 12, wherein, based on the pre-charge enable signal, the pre-charge circuit is further configured to:
receive the pre-charge enable signal through the common gate node, and
pull up the first voltage level of the first output line and the second voltage level of the second output line to the power supply voltage.

14. The image sensor of claim 9, wherein the pre-charge circuit comprises:
a first n-type metal-oxide semiconductor (NMOS) transistor having a drain node to which a ground voltage is applied and a source node electrically connected to each of the plurality of memory banks and the first output line; and
a second NMOS transistor having a drain node to which the ground voltage is applied and a source node electrically connected to each of the plurality of memory banks and the second output line,
wherein a gate node of the first NMOS transistor and a gate node of the second NMOS transistor are electrically connected to each other through a common gate node.

15. The image sensor of claim 14, wherein, based on the pre-charge enable signal, the pre-charge circuit is further configured to:
receive the pre-charge enable signal through the common gate node, and
pull down the first voltage level of the first output line and the second voltage level of the second output line to the ground voltage.

16. The image sensor of claim 9, wherein the at least one photodetection circuit is provided on a first substrate, the analog-digital conversion circuit and the plurality of memory banks are provided on a second substrate, and the pixel driver and the digital logic circuit are provided on a third substrate,
wherein the first substrate is electrically connected to the second substrate and vertically stacked with the second substrate so that the plurality of memory banks on the second substrate are electrically connected to the at least one photodetection circuit, and
wherein the third substrate is electrically connected to the first substrate and the second substrate and vertically stacked with the second substrate so that the pixel driver and the digital logic circuit are electrically connected to at least one of the at least one photodetection circuit, the analog-digital conversion circuit, and the plurality of memory banks.

17. A memory bank comprising:
a plurality of static random access memory (SRAM) cells, each of the SRAM cells configured to store data and connected to a first output line and a second output line; and
a pre-charge circuit configured to control a first voltage level of the first output line and a second voltage level the second output line based on a pre-charge enable signal.

18. The memory bank of claim 17, wherein, based on the pre-charge enable signal, the pre-charge circuit is further configured to:
pull up the first voltage level of the first output line and the second voltage level of the second output line to a power supply voltage, or
pull down the first voltage level of the first output line and the second voltage level of the second output line to a ground voltage.

19. The memory bank of claim 17, wherein the pre-charge circuit comprises:
a first p-type metal-oxide semiconductor (PMOS) transistor having a source node to which a power supply voltage is applied and a drain node electrically connected to the memory bank and the first output line; and
a second PMOS transistor having a source node to which the power supply voltage is applied and a drain node electrically connected to the memory bank and the second output line,
wherein a gate node of the first PMOS transistor and a gate node of the second PMOS transistor are electrically connected to each other through a common gate node.

20. The memory bank of claim 17, wherein the pre-charge circuit comprises:
a first n-type metal-oxide semiconductor (NMOS) transistor having a drain node to which a ground voltage is applied and a source node electrically connected to the memory bank and the first output line; and
a second NMOS transistor having a drain node to which the ground voltage is applied and a source node electrically connected to each of the memory bank and the second output line,
wherein a gate node of the first NMOS transistor and a gate node of the second NMOS transistor are electrically connected to each other through a common gate node.
